(19) United States
(12) Patent Application Publication
(10) Pub. No.: US 2024/0394022 A1
(43) Pub. Date: Nov. 28, 2024

(54) METHOD AND SYSTEM FOR TEMPLATE BASED SOFTWARE AS A SERVICE (SAAS) DATA DOMAIN DETECTION

(71) Applicant: CYTRIO, INC., Wayland, MA (US)

(72) Inventors: Darshan Bhanubhai Joshi, Fremont, CA (US); Pankaj Shashikant Parekh, Fremont, CA (US)

(73) Assignee: CYTRIO, INC., Wayland, MA (US)

(21) Appl. No.: 18/324,316

(22) Filed: May 26, 2023

(51) Int. Cl. G06F 8/35; G06F 9/54; G06F 16/2455; G06F 21/62

(52) U.S. Cl. CPC G06F 8/35; G06F 9/547; G06F 16/24556; G06F 21/6245

(57) ABSTRACT

A method and system for template-based software as a service (SaaS) data domain detection is disclosed. The method includes capturing an information associated with a data model of a SaaS application using a model definition file (MDF), the information being related to at least one of querying a data using SaaS application programming interface (API), organizing the data such that the data from one object is used as a key to query another data item and de-duplicate similar data coming from a plurality of data sources into single entity understandable by humans. The method further includes reading the MDF using a generic connector to interact with the SaaS application for carrying out an instruction encoded in MDF after the MDF is defined and inheriting the MDF by a tenants or a customers using the SaaS app, by copying the MDF where a scanner is running.

### BACKGROUND

### Technical Field

The embodiments herein generally relates to the field of software as a service (SaaS) data domain. More particularly, the embodiments herein relates to a method and a system for template-based software as a service (SaaS) data domain detection.

### Description of the Related Art

Typically, software as a service (SaaS) applications have different data models. The data models include data objects, their attributes, and relationships among objects. Typically, SaaS applications also have application programming interfaces (APIs) for interaction that are typically exposed as representational state transfer (REST)/Hypertext Transfer Protocol Secure (HTTPS) endpoint or graph query language (QL) query. All data privacy and data security applications that support a given SaaS application (APP) need to understand the data model of the SaaS application. The currently known techniques of SAAs data domain detection end up having a separate connector module for each SaaS app, which is a module that has a code specific to a given SaaS app.

Hence, there is a long-felt need for a system and a method for a template-based software as a service (SaaS) data domain detection.

The above-mentioned shortcomings, disadvantages and problems are addressed herein, and which will be understood by reading and studying the following specification.

### SUMMARY

This summary is provided to introduce a selection of concepts in a simplified form that are further disclosed in the detailed description. This summary is not intended to determine the scope of the claimed subject matter.

The present invention aims to address a system and a method for a template-based software as a service (SaaS) data domain detection. The present technology eliminates need for having separate connector for each SaaS application and captures software as a service (SaaS) application data model in a comprehensive Model Definition File (MDF) such that one generic connector can read that MDF and carry out all operations for a given SaaS application. The comprehensive MDF can be written by any one and one does not need to be a developer to be able to write the MDF. This significantly accelerates process of writing new connectors. Also, if SaaS application data model changes, then one just needs to update the MDF without the need to re-write code. The MDF captures all information about SaaS application data model such that one generic driver can interact with any SaaS application as long as there is MDF for that particular SaaS application.

In an aspect, a system for template-based software as a service (SaaS) data domain detection is provided. The system includes a memory for storing one or more executable modules and a processor for executing the one or more executable modules for template-based SaaS data domain detection. The one or more executable modules includes a capturing module, a reading module and an inheriting module. The capturing module is configured for capturing an information associated with a data model of the SaaS application, the information being related to at least one of querying a data using SaaS application programming interface (API), organizing the data such that the data from one data item is used as a key to query another data item and de-duplicating similar data coming from a plurality of data sources into a single entity understandable by humans, using a model definition file (MDF). The reading module is configured for reading the MDF using a generic connector to interact with the SaaS application to carry out an instruction encoded in the MDF, after the MDF is defined. The inheriting module is configured for inheriting the MDF by copying the MDF to a scanner running for a user using the SaaS app.

According to an embodiment, the MDF is authored by an engineer familiar with SaaS app data model and the user includes at least a tenant and a customer.

According to an embodiment, the capturing module is further configured to look for one or more privacy and security related data elements in a published data model using an engineer and to capture a part of the information associated with the SaaS application in the MDF.

According to an embodiment, the reading module is further configured for querying a personal identifiable information (PII) data for each SaaS service by one of connecting to SaaS using an authorization information in MDF, executing APIs using a representational state transfer (REST)/Hypertext Transfer Protocol Secure (HTTPS) and by using sequence of APIs defined in MDF and consolidating final output into predefined format using predefined fields.

According to an embodiment, an execution of the APIs involves chained execution where output from one API is used as a key in other API.

In another aspect, a processor-implemented method for template-based software as a service (SaaS) data domain detection is provided. The method includes capturing an information associated with a data model of a SaaS application using a model definition file (MDF), the information being related to at least one of querying a data using SaaS application programming interface (API), organizing the data such that the data from one object is used as a key to query another data item and de-duplicate similar data coming from a plurality of data sources into single entity understandable by humans. The method further includes reading the MDF using a generic connector to interact with the SaaS application for carrying out an instruction encoded in MDF after the MDF is defined and inheriting the MDF by a tenants or a customers using the SaaS app, by copying the MDF where a scanner is running.

According to an embodiment, steps involved in generic connector to carry out instructions in MDF includes querying a personal identifiable information (PII) data for each SaaS service. The method further includes connecting SaaS using authorization information in the MDF. The method further incudes executing APIs using either a representational state transfer (REST)/Hypertext Transfer Protocol Secure (HTTPS) or other methods using sequence of APIs defined in the MDF. The method further includes consolidating a final output into predefined format using predefined fields and performing consolidation across a plurality of SaaS services.

In another aspect, a processor-implemented method of creating and deploying a model definition file (MDF) is provided. The method includes 1) understanding a software as a service (SaaS) app data model, defining the MDF and testing with a generic connector by a SaaS expert, 2) making the MDF available to a plurality of tenants by developers and operations (devops), 3) customizing the MDF by each of the plurality of tenants to an account for custom objects in an implementation of a SaaS service and repeating the steps 1) to 3) upon occurrence of a significant change in the SaaS data model in a new version.

### BRIEF DESCRIPTION OF THE DRAWINGS

The other objects, features and advantages will occur to those skilled in the art from the following description of the preferred embodiment and the accompanying drawings in which:

FIG. 1 depicts a system diagram for template-based SaaS data domain detection, in accordance with an embodiment herein;

FIG. 2 depicts a flowchart of a process of creating and deploying MDF, in accordance with an embodiment herein;

FIG. 3 depicts a flowchart of the steps involved in carrying out instructions in MDF, in accordance with an embodiment herein; and

FIG. 4 depicts a flowchart of a method for template-based SaaS data domain detection, in accordance with an embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE DRAWINGS

The detailed description of various exemplary embodiments of the disclosure is described herein with reference to the accompanying drawings. It should be noted that the embodiments are described herein in such details as to clearly communicate the disclosure. However, the number of details provided herein is not intended to limit the anticipated variations of embodiments; on the contrary, the intention is to cover all modifications, equivalents, and alternatives falling within the spirit and scope of the present disclosure as defined by the appended claims.

It is also to be understood that various arrangements may be devised that, although not explicitly described or shown herein, embody the principles of the present disclosure. Moreover, all statements herein reciting principles, aspects, and embodiments of the present disclosure, as well as specific examples, are intended to encompass equivalents thereof.

While the disclosure is susceptible to various modifications and alternative forms, specific embodiment thereof has been shown by way of example in the drawings and will be described in detail below. It should be understood, however that it is not intended to limit the disclosure to the forms disclosed, but on the contrary, the disclosure is to cover all modifications, equivalents, and alternatives falling within the scope of the disclosure.

The embodiments herein provide a method and a system for template-based software as a service (SaaS) data domain detection. The present technology eliminates need for having separate connector for each SaaS application and captures a data model of the SaaS application in a comprehensive model definition file (MDF) such that one generic connector can read that MDF and carry out all operations for a given SaaS application. The comprehensive MDF can be written by any one and one does not need to be a developer to be able to write the MDF. This significantly accelerates process of writing new connectors. Also, if SaaS application data model changes, then one just needs to update MDF without the need to re-write the code.

According to one embodiment herein, the MDF captures all information about SaaS application data model such that one generic driver can interact with any SaaS application as long as there is MDF for that SaaS application. The MDF captures information about all necessary objects, object relationships, object attributes including attribute criticality and whether attribute is privacy related, how to query given object and attributes, order in which to execute query operations, chained query operations (Query one object first, get some attribute and then use that attribute to query another object, if multiple SaaS applications return similar data (for example, Salesforce and Oracle financials both have credit card data for customer)), then merge and de-duplicate data and create category report for privacy related data or critical business data and so on. In several embodiments, the MDF is authored by an engineer familiar with SaaS app data model. The engineer looks for all privacy and security related data elements in published data model and captures couple of things about them in MDF comprising how to query that data using SaaS API, how to organize that data such that data from one object can be used as a key to query another data item and de-duplicate similar data coming from multiple data sources into single entity understandable by humans. In several embodiments, the MDF is human readable and editable JavaScript Object Notation (JSON) file. Once such file is defined, generic connector can interact with that software as a service (SaaS) application to carry out all necessary operations. The generic connector reads the MDF and carries out instruction encoded in MDF. That way the MDF can be thought of as a source code but it does not require programming knowledge.

According to an embodiment herein, the MDF is developed by the engineer. After proper testing, it is pushed to a SaaS common location. All tenants or customers using that SaaS app inherit the MDF by copying the MDF to where the scanner is running. There are two deployment modes for scanner including an on-prem or a cloud. The MDF defines some of the key parameters needed for querying privacy and security related data. Typically, one may need to change MDF for following reasons:
(1) Underlying data model from software as a service (SaaS) changed such that privacy and security related data access application programming interface (API) changes; and
(2) Customer has a custom implementation.

In case of reason (1), the engineers will update the MDF and upload to a software as a service (SaaS) and customer copy will be refreshed. In case of reason (2), customer (with the help of the company if needed) can override some of the attributes by creating a new, add-on MDF. Attributes and methods defined in that file takes precedence over base MDF supplied by the company. The syntax for add-on MDF is same as base MDF.

The MDF is created by engineer knowledgeable with given software as a service (SaaS). The connector is tested by the engineers with a generic connector making sure it can work in tenant environment in both cases, where a tenant is using a default data model or they have custom implementation.

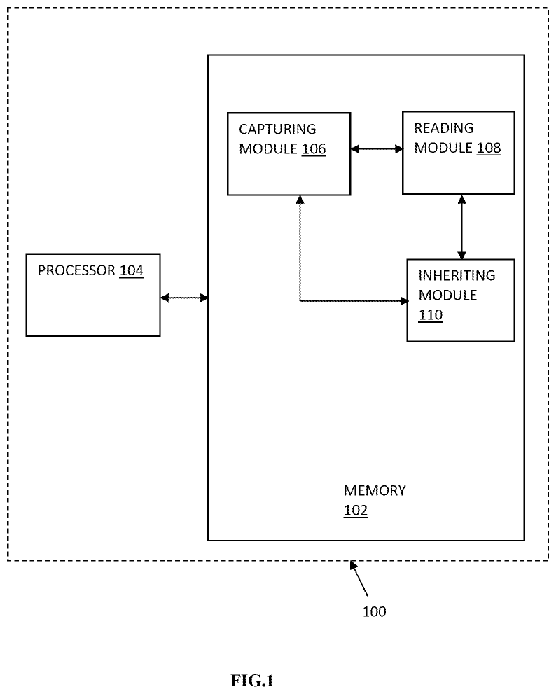

FIG. 1 depicts a system 100 for template-based SaaS data domain detection, in accordance with an embodiment herein. The system 100 comprises a memory 102 for storing one or more executable modules and a processor 104 for executing the one or more executable modules for template-based software as a service (SaaS) data domain detection. The one or more executable modules comprises a capturing module 106, a reading module 108 and an inheriting module 110. The capturing module 106 is configured for capturing an information associated with a data model of the SaaS application, the information being related to at least one of: querying a data using SaaS application programming interface (API), organizing the data such that the data from one data item is used as a key to query another data item and de-duplicating similar data coming from a plurality of data sources into a single entity understandable by humans, using a model definition file (MDF). The capturing module 106 is further configured to look for one or more privacy and security related data elements in a published data model using an engineer and to capture a part of the information associated with the SaaS application in the MDF. The MDF is authored by an engineer familiar with SaaS app data model and wherein the user comprises at least a tenant and a customer. The reading module 108 is configured for reading the MDF using a generic connector to interact with the SaaS application to carry out an instruction encoded in the MDF, after the MDF is defined. The reading module 108 is further configured for querying a personal identifiable information (PII) data for each SaaS service by one of: connecting to SaaS using an authorization information in MDF, executing APIs using a representational state transfer (REST)/Hypertext Transfer Protocol Secure (HTTPS) and by using sequence of APIs defined in MDF and consolidating final output into predefined format using predefined fields. An execution of the APIs involves chained execution where output from one API is used as a key in other API. The inheriting module is configured for inheriting the MDF by copying the MDF to a scanner running for a user using the SaaS app.

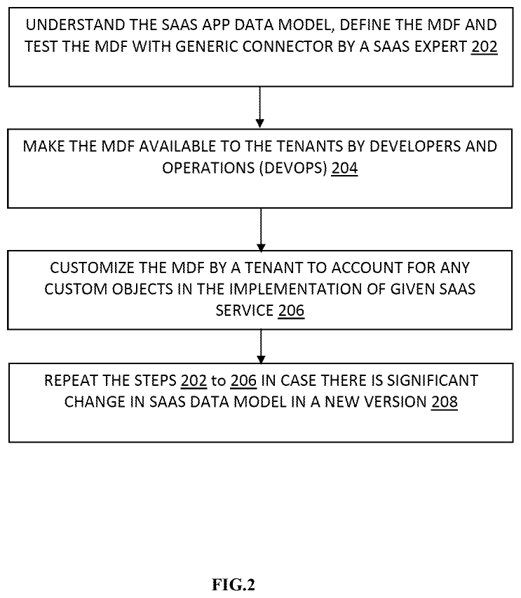

FIG. 2 depicts a flowchart of a process of creating and deploying MDF, in accordance with an embodiment herein. At step 202, the SaaS app data model is understood, the MDF is defined and tested with generic connector by a SaaS expert. At step 204, the MDF is made available to tenants by developers and operations (devops). At step 206, the MDF is customized by tenant to account for any custom objects in the implementation of given SaaS service. At step 208, the steps 202 to 206 are repeated in case there is significant change in SaaS data model in a new version.

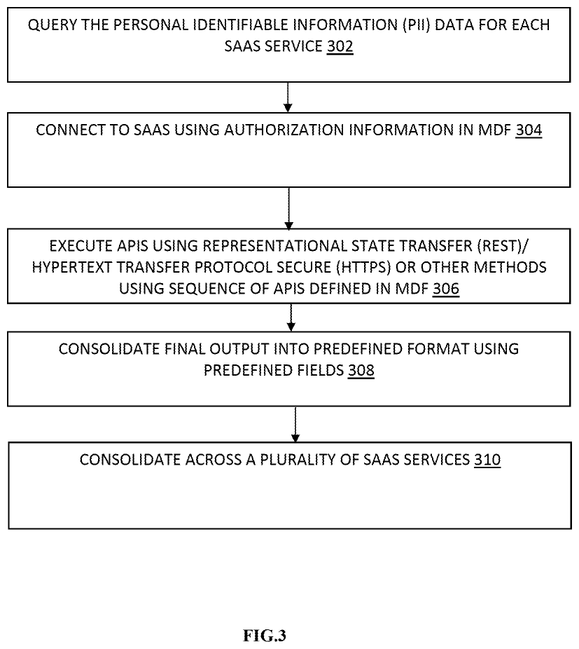

FIG. 3 depicts a flowchart of the steps in generic connector to carry out instructions in MDF, in accordance with an embodiment herein. At step 302, the personal identifiable information (PII) data is queried for each SaaS service. At step 304, SaaS is connected using authorization information in the MDF. At step 306, APIs are executed using REST/HTTPS or other methods using sequence of APIs defined in the MDF. The execution may involve chained execution where output from one API is used as a key in another API. At step 308, final output is consolidated into predefined format using predefined fields. At step 310, consolidation is done across a plurality of SaaS services. For example, if both Salesforce and Service now returned email addresses, then see if they are different. If yes, make a list of email addresses. If they are same, then remove duplicate and include only one instance.

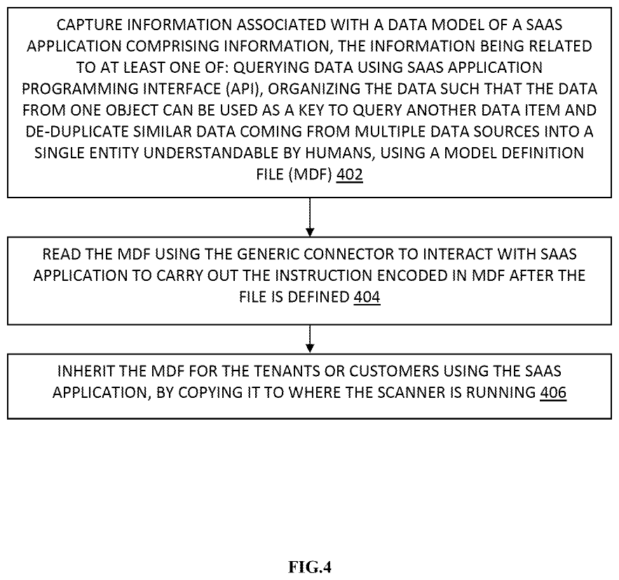

FIG. 4 depicts a flowchart of a method for template-based SaaS data domain detection, in accordance with an embodiment herein. At step 402, the information associated with a data model of a SaaS application is captured using a MDF, the information being related to at least one of: querying the data using SaaS application programming interface (API), organizing the data such that the data from one object can be used as a key to query another data item and de-duplicate similar data coming from multiple data sources into single entity understandable by humans. The MDF is authored by the engineer familiar with SaaS app data model. At step 404, the MDF is read using the generic connector to interact with SaaS application to carry out the instruction encoded in MDF after the file is defined. At step 406, the MDF is inherited by the tenants or the customers using the SaaS app, by copying it to where the scanner is running.

The various embodiments of the present technology eliminates need for having separate connector for each SaaS app. The present invention captures the data model of the SaaS application in a comprehensive MDF such that one generic connector can read that MDF and carry out all operations for given SaaS app. The MDF can be written by anyone as one does not need to be a developer to be able to write MDF. This significantly accelerates process of writing new connectors. Also, if SaaS application data model changes, then one just needs to update MDF without the need to re-write the code. Also, the SaaS application data is identified without writing application specific connector. The MDF abstracts out all necessary information about SaaS app in one simple to create and use file that does not require coding knowledge. The known alternatives are inefficient and requires writing separate connector for each SaaS app. The present technology provides data privacy, data security and data domain identification. The present technology provides the MDF that defines some of the key parameters needed for querying privacy and security related data. The present technology provides the MDF that is human readable and editable JavaScript Object Notation (JSON) file.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

The scope of the embodiments herein will be ascertained by the claims to be submitted at the time of filing a complete specification.

What is claimed is:

1. A system for template-based software as a service (SaaS) data domain detection, the system comprising:
a memory for storing one or more executable modules; and
a processor for executing the one or more executable modules for template-based SaaS data domain detection, the one or more executable modules comprising:
a capturing module for capturing an information associated with a data model of the SaaS application, the information being related to at least one of: querying a data using SaaS application programming interface (API), organizing the data such that the data from one data item is used as a key to query another data item and de-duplicating similar data coming from a plurality of data sources into a single entity understandable by humans, using a model definition file (MDF);
a reading module for reading the MDF using a generic connector to interact with the SaaS application to carry out an instruction encoded in the MDF, after the MDF is defined; and
an inheriting module for inheriting the MDF by copying the MDF to a scanner running for a user using the SaaS app.

2. The system of claim 1, wherein the MDF is authored by an engineer familiar with SaaS app data model and wherein the user comprises at least a tenant and a customer.

3. The system of claim 1, wherein the capturing module is further configured to look for one or more privacy and security related data elements in a published data model using an engineer and to capture a part of the information associated with the SaaS application in the MDF.

4. The system of claim 1, wherein the reading module is further configured for querying a personal identifiable information (PII) data for each SaaS service by one of: connecting to SaaS using an authorization information in MDF, executing APIs using a representational state transfer (REST)/Hypertext Transfer Protocol Secure (HTTPS) and by using sequence of APIs defined in MDF and consolidating final output into predefined format using predefined fields.

5. The system of claim 4, wherein an execution of the APIs involves chained execution where output from one API is used as a key in other API.

6. A processor-implemented method for template-based software as a service (SaaS) data domain detection, the method comprising:
capturing an information associated with a data model of a SaaS application using a model definition file (MDF), the information being related to at least one of: querying a data using SaaS application programming interface (API), organizing the data such that the data from one object is used as a key to query another data item and de-duplicate similar data coming from a plurality of data sources into single entity understandable by humans;
reading the MDF using a generic connector to interact with the SaaS application for carrying out an instruction encoded in MDF after the MDF is defined; and
inheriting the MDF by a tenants or a customers using the SaaS app, by copying the MDF where a scanner is running.

7. The processor-implemented method of claim 6, wherein steps involved in generic connector to carry out instructions in MDF comprises:
querying a personal identifiable information (PII) data for each SaaS service;
connecting SaaS using authorization information in the MDF;
executing APIs using either a representational state transfer (REST)/Hypertext Transfer Protocol Secure (HTTPS) or other methods using sequence of APIs defined in the MDF;
consolidating a final output into predefined format using predefined fields; and
performing consolidation across a plurality of SaaS services.

8. A processor-implemented method of creating and deploying a model definition file (MDF), the method comprising:
1. understanding a software as a service (SaaS) app data model, defining the MDF and testing with a generic connector by a SaaS expert;
2. making the MDF available to a plurality of tenants by developers and operations (devops);
3. customizing the MDF by each of the plurality of tenants to an account for custom objects in an implementation of a SaaS service; and
repeating the steps 1) to 3) upon occurrence of a significant change in the SaaS data model in a new version.
